(19) United States
(12) Patent Application Publication
(10) Pub. No.: US 2007/0208688 A1
(43) Pub. Date: Sep. 6, 2007

(54) Telephony based publishing, search, alerts & notifications, collaboration, and commerce methods

(76) Inventors: Jagadish Bandhole, Saratoga, CA (US); T.K. Lakshman, San Carlos, CA (US); Sekaran Nanja, San Jose, CA (US)

Correspondence Address: Fonemine c/o Murabito, Hao & Barnes LLP, Two North Market Street, 3rd Floor, San Jose, CA, 95113, US

(21) Appl. No.: 11/703,894

(22) Filed: Feb. 7, 2007

Related U.S. Application Data
(60) Provisional application No. 60/771,724, filed on Feb. 8, 2006.

(51) Int. Cl. G06F 7/00

(52) U.S. Cl. 707/1

(57) ABSTRACT

Systems, apparatus and methods are described that provide data services including publication and viewing of personal and business content on phone devices via phone networks. The invention provides systems, methods, tools and delivery systems useful in the publication, sharing, viewing, searching, communication, transmission, alerting, notification & feedback, collaboration and commerce on telephone networks.—Subscribers may publish content specifically targeted for phones and view such content on existing phone devices, on phone networks. Subscribers may search for relevant content on phone devices and may send/receive alerts that can be tied to their search operations. Subscribers may also create, join, participate in communities via their phone devices as well as, view, and update content designed specifically for such phone communities. Commerce can also be initiated and automated end-to-end via Fonemine services, protocols, and abstractions that are described in this invention. The systems, methods and apparatus for such data services can be optimized for use in mobile devices and may be accessed using existing telephones and telephone networks.

This application claims the benefit under 35 U.S.C. §119(e) of U.S. Provisional Application Ser. No. 60/771,724, filed Feb. 8, 2006, to Bandhold et al., entitled “Telephony Based Publishing, Search, Alerts & Notifications, Collaboration, And Commerce Methods,” which is incorporated herein in its entirety.

### CROSS-REFERENCE TO RELATED APPLICATIONS

The present application is related to utility application No. 60/732,792, filed Nov. 1, 2006 and titled “Platform For Telephone-Optimized Data and Voice Services,” and utility patent application Ser. No. 11/644,766, filed Dec. 22, 2006 and titled “Service Initiated Voice Chat” which are incorporated herein by reference for all purposes.

### BACKGROUND OF THE INVENTION

1. Field of the Invention

The present invention relates to data communications and more particularly to voice integrated data communications in data access devices including telephones and computers.

2. Description of Related Art

Today's mobile telephones provide limited data services in the following forms (a) alerts and notifications via text messaging, and (b) data communications and data access via mobile-browser access to the world-wide-web via data networks such as EVDO, GPRS, EDGE, 3G, UMTS etc. and (c) business applications such as email access to corporate mail servers. The following are the limitations of these services.

Data services are almost non existent for land-line telephones. Furthermore, data services are almost always independent in use cases, protocols, and workflow from voice communications. Data services are not tailored for telephone devices. Data services are based on content that is often obtained from the world-wide-web, which is far too static, verbose, and lacks relevance to the telephone user, hence data services do not seamlessly mesh with existing voice services. Almost all voice communications involves human voice representing user generated content, and this is not so for most data-services. Each of the above forms has further limitations:

Form (a) services are rather static and limiting in nature since this form of service implements a push mechanism to which users must subscribe; additionally, the content source determines in a static manner which content should be pushed to the—subscribers, when the push should occur and how the push should be structured. Once the push service is so configured, it just pushes alerts and notifications via text messaging without any heed for the target device and can thus soon become annoying;

Form (b) services have been universally difficult to adopt, primarily because these services require a separate data plan (in addition to voice services), and further require accesses the world wide web which is not designed to leverage, display or get input from telephone devices which have limited display area, very limited input capabilities, low power, low bandwidth, high associated expense, limited data access, and have unpredictable periods of disconnection, and suffer from high latency. Furthermore, the World Wide Web ignores key characteristics of phone device such as end-point location, end-point identity and state, and the time that the communication is initiated.

Form (c) services are primarily designed for corporate consumers, and while they have found acceptance in push-email services for the corporate consumer, they have not found acceptance among the consumer masses (who are not necessarily with a corporate email account) that nevertheless own and use mobile and landline telephones. Furthermore, these services also require an underlying data-plan

All of the above are designed primarily for service to subscriber communications, and do not provide mechanisms for the telephone subscribers to publish, share, communicate, collaborate, notify, and search content amongst themselves.

Nor are these services designed to address the unique capabilities, limitations, and needs of the telephone subscriber.

Searching data for relevant content is a formidable challenge for services that provide search capabilities to telephone end-points. The telephone's limited display characteristics coupled with limited input capabilities, limited bandwidth and high latency mandates new metrics to improve the user experience: these include very few relevant results to be displayed and ordered, categorization of the relevant results, leveraging of subscriber demographics including identity, location, and state within search inputs, search refinement via user selection and input, and finally going beyond text search to media search that includes voice, video, images, ring tones, wall-paper, pictures, telephone numbers, and such objects that are commonly accessed on telephones.

Alerts represent relevant content sent to the requester in a timely manner. Today's alerting mechanisms are largely static, based on SMS, that provide no aggregation of content or of resulting alerts. Different content alerts have to be subscribed to via different mechanisms and commands and at different times. Farther alerts are only pushed to the mobile subscriber, there is no mechanism for subscribers to pick up or schedule alerts upon their own initiative. Alerts are not multimodal (i.e. voice data or text), alerts are also not prioritized, nor do they leverage subscriber presence or more generally subscriber state (e.g., is she awake? is she in Vegas?). The subscriber has no filtering mechanisms for selectively picking alerts on the device side: the only filters are specified on the service side when the subscriber signs up. Alerting is also not tied to standard calendar and scheduling functions that are available on mobile devices or on the server side. Finally, accessing alerts is an all or none proposition with no selectivity.

Today's data services provide very limited collaboration capabilities, mainly through email services which are more notificational than collaborational. User communities are supported on the world-wide-web but are again static in nature: they assume that the endpoints are computers/browsers/not mobile devices or even people who are on the go. This prevents the subscriber location, state, and identity from being leveraged by communities. For example, a community of all people in a train station is a dynamic community with constantly changing subscriber base which have different interests over time that are not representable nor usable within the community. Other examples of communities include a neighborhood watch, a school district, a Parents Teachers Association for a specific class in a school, a home owner's association, etc. Community content that is modifiable, and viewable is not available for telephone devices primarily because such content is again designed for the world-wide-web and is not designed for easy updates or viewing on mobile devices.

Collaboration is a great way to plan, coordinate, share, keeping up-to-date, and for polling feedback in a peer-driven manner. Unfortunately none of these capabilities are supported natively on telephone devices, nor integrated with alerting and other forms of telephone communication.

Conference voice calling is available but typically only for corporate subscribers. Furthermore, conference calling is “scheduled” rather than impromptu/timely, requires knowledge of the telephone number of each participant, and is typically initiated via a computer (not a mobile phone). Notification of the conference call, together with simple capabilities such as screening of participants is just not available to the consumer masses, and not certainly for more than 3-way calling! Furthermore the voice side of conference calling on mobile devices do not complement, leverage and integrate with the data side of access on mobile devices

Mobile commerce has taken off in certain countries such as Japan and Korea, but is not yet feasible (in terms of infrastructure and services) in many other parts of the world. Unfortunately the absence of rich data communication abstractions for search, alerting, notification, collaboration, and integration with existing telephone communications makes it challenging to introduce mobile commerce services in many parts of the world. The fundamental problems include lack of content specifically designed for telephones, lack of protocols to address mobile commerce, and lack of abstractions for publishing, sharing, searching, notification, and communications.

### BRIEF SUMMARY OF THE INVENTION

Systems, apparatus and methods are provided that overcome problems associated with the development, deployment, and delivery of information services such as publishing, communication, search, alerts & notifications, feedback, collaboration, and commerce on data access devices such as telephone devices on telephone networks.

A content system targeted from the ground up for telephone devices accessible on voice and data networks (Fonet) is described. Fonet enables subscribers to publish, share, and view basic units of content abstraction for phone devices (called Fonepages). Any individual subscriber can publish a fonepage which consists of media objects such as text, pictures, audio, video, representing the subscriber's identity and interest& Additionally, business subscribers can publish fonepages which describe their business characteristics such as location, hours of operation, services/products, specials and sales, contact information etc. Such content is accessed/viewed/heard simply by “calling” the subscriber on the telephone, such a call would result in the called subscribers fonepage being returned back to the caller for “viewing” (either via text, voice or just data) and subsequent action, such as selection, data input session based activities, notification, voice communication, search, and commerce.

A locate component enables subscribers to get additional information about the called subscriber and/or to view the fonepage for the called subscriber wherein the called subscriber can be a business or another personal subscriber.

Furthermore, a phone optimized search component enables subscribers to search for specific fonepage content or for other subscribers by specifying keywords and categories they are searching for, and by directing the search through additional options such as location of both the caller and the desired entity, identity and preferences of the caller and the time the call is made. Such searches are performed only via the phone network and result in a highly concise and relevant response set that can be easily viewed/heard on telephones. Search components enable seamless switch from search function to different mechanisms including voice, text, and data for “viewing” mobile search results, and communicating with the found results (be they businesses or other subscribers) and back!

An alerting and feedback component is described which enables subscribers to create, select, and aggregate content alerts they wish to obtain from different sources, tie up alerting with scheduling and calendar functions on the client device to selectively filter content on the client device, provide voice text and data (i.e. multimodal) alerts and reminders, integrate with other forms of communication such as instant messaging which also provide alerting and notificational services especially from “friends” and enabling selection operations on the alerts

A collaboration component is then described which enables subscribers to create groups of “like minded” individuals that participate in a community designed optimally for interaction on phone devices wherein the interaction can include publishing and voice communication; sharing, viewing, notifying and responding. Communities can be moderated, with different roles for different subscribers, enable selective viewing and modification of content and support sharing of “community content” amongst the subscriber base. Communities are also integrated with alerts and notifications. Communities can be used to plan, coordinate, keep up to date, and to elicit feedback from members.

A commerce component is finally described which enables subscribers using a telephone, to initiate an end to end commerce activity starting from searching for an item, to comparison, to consumer feedback and ratings, to selection, to reservation, to purchase, to pickup and then to support. The commerce component leverages the search, collaboration, notifications, and feedback capabilities described previously.

### BRIEF DESCRIPTION OF THE DRAWINGS

The present invention is illustrated by way of example, and not limitation, in (lie figures of the accompanying drawings in which like references denote similar elements, and in which:

FIG. 1 illustrates an architectural overview of embodiments of the invention;

FIG. 2 illustrates an alert generation system;

FIG. 3 is a block diagram of a search process in one embodiment;

FIG. 4 is a flowchart illustrating a search process in one embodiment of the invention;

FIG. 5 is a block diagram illustrating a collaboration configuration; and

FIG. 6 is a flowchart describing mobile commerce in one embodiment.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention. In the drawings, like components, services, applications, and steps are designated by like reference numerals throughout the various figures. Where certain elements of these embodiments can be partially or fully implemented using known components, only those portions of such known components that aft necessary for an understanding of the present invention will be described, and detailed descriptions of other portions of such known components will be omitted so as not to obscure the invention, Further, the present invention encompasses present and future known equivalents to the components referred to herein by way of illustration.

Embodiments of the present invention provide systems and methods for publishing content to Fonet (the Phone content repository that is designed specifically for viewing on phones and communicating via phone networks), for searching content that has been published on Fonet or that is available online on Fonet by virtue of having it synthesized from the world-wide-web, but specifically for phones and such limited capability mobile devices, for generating alerts and notifications, based on group activity, for obtaining feedback from consumers, improved collaboration tools and tools that promote e-commerce. Certain embodiments implement systems and methods described in the related Applications recited above.

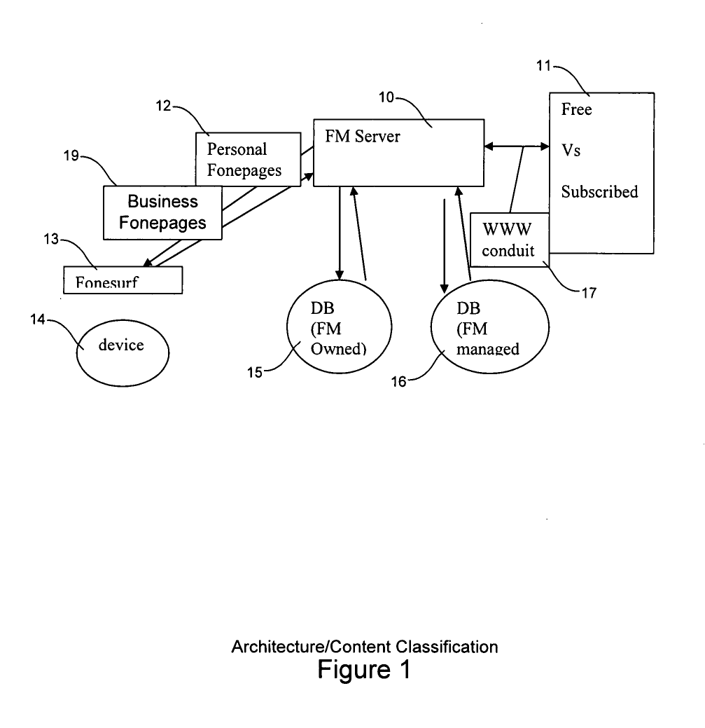

Referring to FIG. 1, many embodiments provide a system that can deliver content 11 that may be openly available, free, or available by subscription. Free content may be available to pre-identified users of a system while openly available content is provided upon request to any user. Typically, subscription services charge users on some combination of base charge and content usage. For example, a user may pay a subscription fee that allows a predetermined number of accesses within a given time period, and may be charged per access in. excess of the predetermined number of accesses. Free, openly available and subscription content may be available on the world-wide web (“WWW”) and many embodiments of the invention provide access to internal content and enable access to WWW based content through a WWW conduit 17. Internal content may be maintained as Fonemine-owned content 15 and Fonemine-managed content 16. Fonemine-owned content 15 typically includes information that has been generated, organized, optimized or otherwise processed by Fonemine. Fonemine managed content 16 comprises information identified by one or more users for maintenance within the Fonemine system and can include adaptations of Fonemine-owned information and user generated information. WWW-based content, Fonemine-owned content 15 and Fonemine-managed content 16 information are typically managed by a Fonemine server 10. The Fonemine server 10 may include database managers, WWW search engines, indexing systems and local storage for maintaining copies of managed data. Fonemine server 10 can format content as Fonepages 12 under owner control where Fonepages 12 may be accessed by a user device 13 executing a Fonemine client such as Fonesurf 13.

Search from Mobile Devices

In certain embodiments of the invention, advanced, customized searching capability is provided. Searches of various types can be executed including searches based on keywords, names, local contexts relevant to the person conducting the search, categories, telephone subscriber directories and business directories and so on.

In certain embodiments, searches are initiated by a user of mobile device 14 equipped with agent software and adapted to receive and display Fonepages. The agent software typically enables seamless communication between mobile device and Fonemine server regardless of underlying communications protocols. The agent can identify device capabilities and can cause Fonepage content to be adapted to accommodate display and input limitations of mobile device 14. Thus, Fonepages may be reliably reviewed by a user.

In certain embodiments, searches are initiated by a user of mobile device 14 via the use of their mobile wap browser to input search criterion, or even via text messaging. Fonepage content can be structured and can include well-defined fields and attributes having known or anticipated values. Examples of Fonepages include personal Fonepages and business Fonepages. This structure can facilitate directed searches based on keywords and categories because the structure of content can be specified a priori, and leveraged during search. In some embodiments searches employ Fonepages to generate search criteria and parameters to present to the search engine and to present search results back to the viewers.

In certain embodiments, Fonepages are employed to optimize searches by reducing the responses, down to, for instance, a small number of answers (e.g. 3-5 responses may be displayed). Searches can be distributed, thereby speeding the search process and searches may be directed by users such that specific sources of content are identified for searching. In many embodiments, searches are based on user preferences that may be automatically included as search parameters or may be specified prior to search initiation. In some embodiments, searches can be directed by prior results and histories of prior searches. Results and search histories may be maintained on Fonemine servers.

In many embodiments, searches are executed on a variety of content including Fonemine owned content 15, Fonemine managed (Fonemine community content) 16, third party content 11 including openly sourced content and content available by subscription.

In certain embodiments, searches are implemented using FonP (utility application No. 60/732,792, filed Nov. 1, 2006 and titled “Platform For Telephone-Optimized Data and Voice Services,”) for communication between mobile device and FM Server. Communication involving mobile devices can use any suitable protocol, including SMS, GPRS/EDGE/EVDO, 3G and Satellite.

Fonemine Search Uniqueness

In some embodiments of the invention, searches adopt certain unique characteristics. For example, predetermined user preferences may direct or influence searches and may provide specific search contexts. The searches may be location aware such that the location of the mobile phone and the location of content may be factored into a search. For example, results local to the mobile telephone may be prioritized. Searches can be session and user-focused, such that initial searches may be based on histories of prior searches and prior activities in a communication session.

In certain embodiments, a limited number of results are returned as determined by user preferences and device capabilities. Typically, search results can be provided quickly because of factors including the inclusion of context, preferences and histories.

In many embodiments results can be cached on a Fonemine server at locations determined by a user. These cached results are typically maintained as Fonepages. Results can be stored if desired by the user or at the direction of the user through preferences and configuration. These stored results are typically maintained as Fonepages and may be retrieved by searching a Fonemine server associated with the user.

In certain embodiments, search results are provided to users with a contact included in the results. Using the contact, a user may place a call or establish a Fonepage session with a provider of content. Alternatively, the Fonemine service may initiate a call to the provider of content as well as the user, hence bridging the two. Various commercial applications can be enabled using searches to, for example, identify a potential provider of a service or product with a capability of immediate direct contact with the provider, In some embodiments, content can be provided by one or more brokers and the Fonemine server 10 can provide information that may be used by the broker and provider to calculate fees for brokering services.

In certain embodiments, searches can be scheduled to occur at a specific time or upon occurrence of certain identified events. For example, when it is known that certain content will become available when certain indexing will have occurred, a search can be commenced or resumed. In some embodiments, servers can cache results obtained from searches of subscription content or other content available at a fee. Typically, prior results and intermediate results can be stored and aggregated based on sign-on and authentication information at a Fonemine server. In some embodiments sign-on and authentication information may be maintained for simplifying searches of paid content.

Many embodiments provide secure search capabilities in which the Fonemine server can limit access to certain content. Typically, alerts are transmitted when search results are obtained that meet the search criteria and when a search is completed without success.

In certain embodiments, temporal configuration of searches is provided. For example, sewers can be configured to execute selected searches on a periodic basis. Servers can also be configured to identify information that may change or have changing value over time. In this manner, search results can be prioritized based on future value of content as well as information related to past state of the content obtained, for example, when the content was last indexed. In many embodiments, the search tool may be based on a strategy that includes use of indexing, relevance and monetization metrics. In other embodiments, the search tool may ignore indexing, relevance and monetization metrics. In certain embodiments, search categories can be defined by combinations of information received from consumer, user, subscriber, content provider, content owner/publisher and service providers.

In certain embodiments, search input can be interpreted in the context of mobile communications to mean specific things, e.g., slangs and acronyms, that are commonly used in mobile communications.

Actions to be Taken Upon Search Result Display

In certain embodiments, servers may be configured to execute one or more actions upon completion of a search. For example, a call may be placed by the searcher or by the Fonemine service that provides search, to an entity identified in the search results. In some embodiments, calls made to such entities can be logged and the log may be provided as a use metric for revenue generation. In another example, an identified entity may call the searcher directly or by mediated call. Typically, mediation is provided by Fonemine service provider. In another example, the results generated may be used to determine if a refined search should be executed.

In many embodiments, user input can be used to direct and control the search by providing additional context. Such input includes but is not limited to user identity, user state, user preferences, user location, categories of interest, search history, time the search is initiated, the type of content the user is interested in, the time window (content lifetime and/or when the content was published) that the user is interested in.

In many embodiments, search results may be stored with the search request and parameters for various purposes including caching for performance, and scalability. Search results can be summarized, sorted or more details provided upon request. Additionally, the saved search request and parameters may be used in generating a repeating search or a delayed search. Since search can be tied to notification, the ability to get notified when an event occurs in the future (such as a search resulting in a specific answer) is a powerful way of performing search repeatedly as well as in a delayed manner on behalf of the requester! Such search capabilities may be used for time critical events (such as getting informed when tickets for a concert go on sale in the future).

Search Process

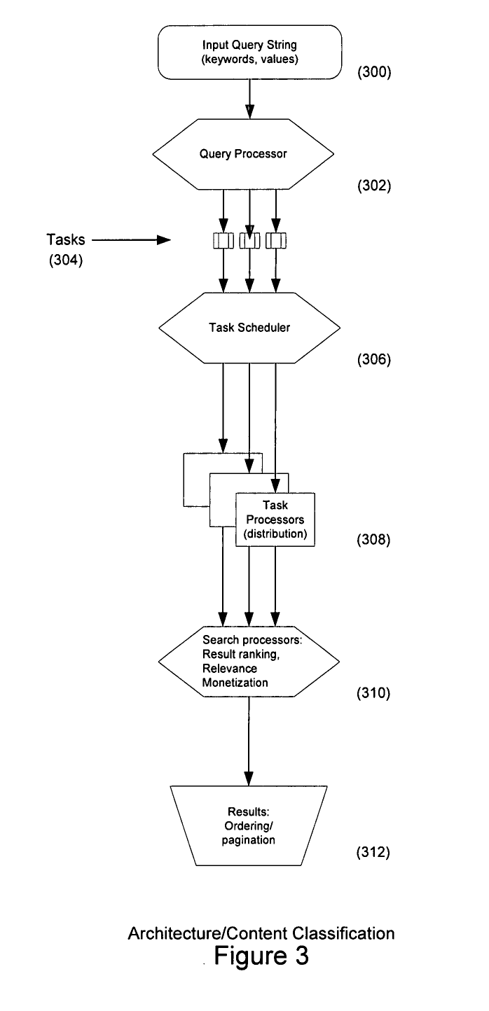

Referring to FIG. 3, a block diagram illustrates the processing of searches in embodiments of the invention. Typically, a user inputs a query at 300 where the query may comprise a string that includes keywords, values sought and search parameters. A query processor 302 may parse the query string to extract and format search terms. Based on the content of the query string, one or more tasks 304 may be created. Each of the one or more tasks 304 can perform a portion of the search. For example, one task may be search for Fonemine managed content while another task may search WWW content. In another example, a task may search repetitively based on a configured search schedule. Task scheduler 306 configures one or more processors to execute tasks 304. Task scheduler typically sets system priorities and identifies storage for results and allocates system resources as required. Task processors 308 can execute tasks 304 as scheduled by task scheduler 306. One or more task processors can be provided on a server or other processor and, in many embodiments, task processors 308 can be distributed among a plurality of servers located in geographically distant sites. This distribution can enable more efficient searching. Search processors 310 may be assigned to process search results based on preconfigured criteria including rankings, relevance and monetization. Rankings and relevance can be determined by prior search histories, quantity of references to and from found content, voting and any other suitable or desired criteria. Monetization can be used to assign higher value to a search result based on content promotion by a content provider such that, for a fee, specific matching results are prioritized for a search. Results can be collated and ordered at 312 and can be formatted for delivery to a user device.

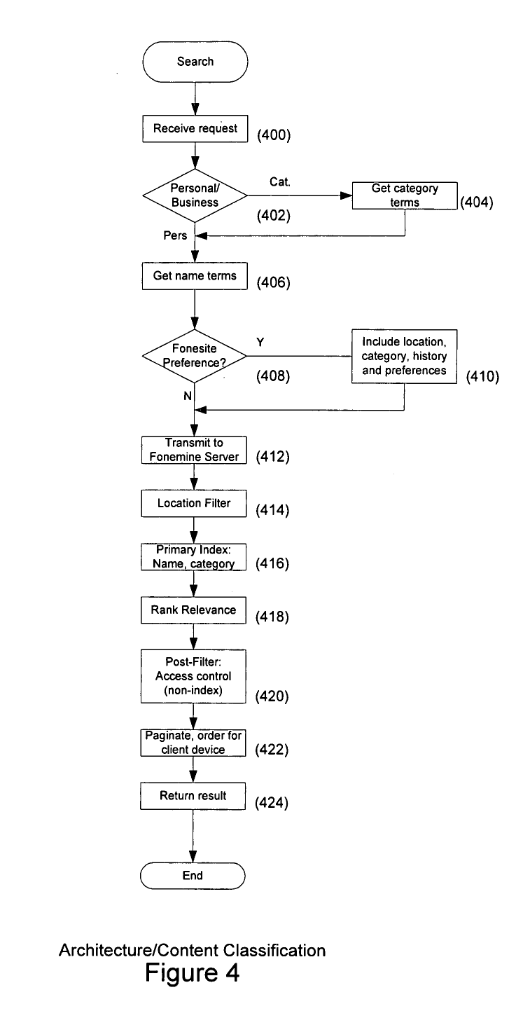

The flowchart of FIG. 4 shows a typical search process. A search request is received at step 400 and parsed for search parameters. If, at step 402, it is determined that the search is based on factors including category information, then the search is configured with category information at step 404. At step 406, any name information is received as search criteria. At step 408, if the search request includes references to subscriber information, then Fonemine system information can be added to the search terms. Fonemine system information can include location, preferred categories, history of prior searches, history of prior search results and other subscriber preferences. At step 412, the search terms are dispatched to a Fonemine server for execution of a search.

The search results can be filtered at step 414 for location relevance. Location relevance may be defined by the location of the requesting user, by preferences provided by the user and by content provider. Primary indices including names and categories are applied at step 416 and, at step 418, results are ranked by relevance. At step 420, results may be blocked by access control systems. For example, a user may not be authorized to access certain types of data without subscribing to services provided by the content provider. At step 422, final results are configured for display on the user device. In some embodiments, device capabilities need not be known because the results are provided as one or more Fonepages. At step 424, the results are transmitted to the user device.

Alerts and Alerting Component

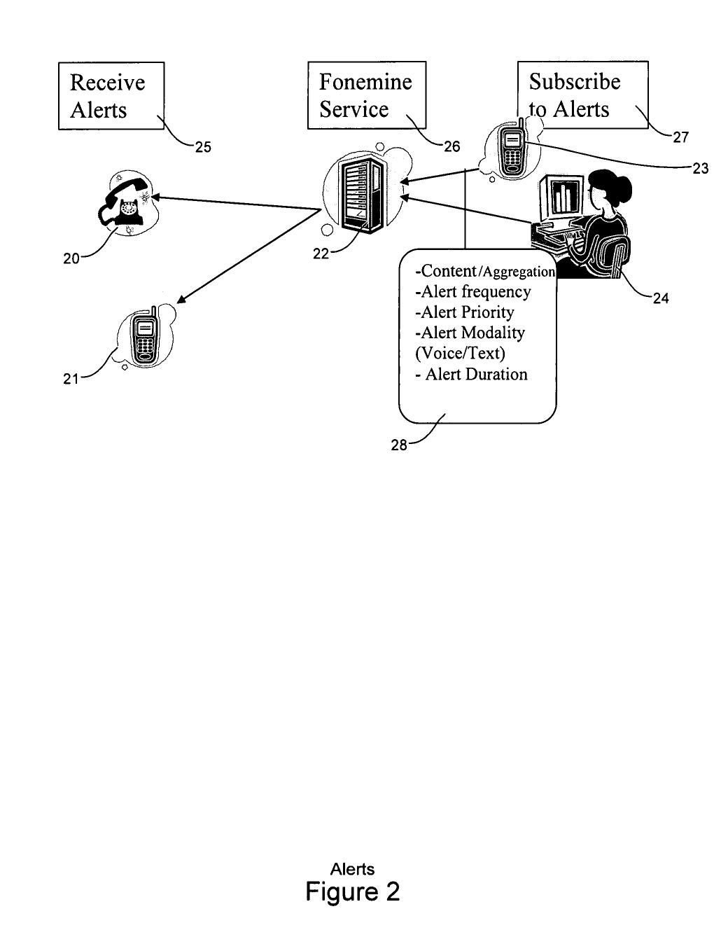

Referring to FIG. 2, embodiments of the invention provide an alerts service that can be used to deliver time sensitive information to a user device 20, 21. A subscriber 24 may create one or more alerts on a Fonemine server 22 using a computer or mobile telephone 23. Alerts can be multimodal having a voice component for delivery to land-line telephones 20 or mobile telephones 21 and can have a text component for delivery to mobile telephones 21 as well as a data component that is pulled or pushed via wap or other mobile internet protocols. Alerts may be delivered based on a predetermined schedule, presence of a specified user or on a periodic basis. In some embodiments, Fonemine servers 22 can broker presence such that the system may determine whether two or more parties are available for connection and can send alerts between devices to obtain presence and notify status of presence. Alerts may be delivered repetitively or scheduled depending on configuration.

In many embodiments, Alerts can be transmitted for delivery upon generation. However, in some embodiments, the system may be configured to hold alerts for delivery at a desired time. Alerts may be held and delivered based on certain conditions being met such as availability of a targeted user. Alerts may be periodic in nature and the alert generation system is frequently integrated with a calendaring system. In certain embodiments, alerts may be prioritized and delivery scheduling can be overridden based on priority settings.

In certain embodiments, Fonemine server 22 may use alerts for scheduling events where all attendees can not only be notified, but also participate in scheduling and decision making process for the events, via alerts.

In certain embodiments, Fonemine server 22 may use alerts for polling purposes, and in general to obtain feedback on published content. Typically, the server can aggregate responses and alerts from a plurality of devices and can use the alert system to provide results based on preset conditions. For example, a quorum may be set whereby Fonemine server 22 may send an alert to one or more devices when a predetermined number of devices have notified the Fonemine server 22 that they are present and available for a scheduled meeting, conference call or collaboration. Notification of presence may be accomplished using alerts. In such embodiments, alerting conditions and polling periods may be determined by subscriber configuration. In one example, alerts can facilitate system services including event scheduling, basic “chat” services, group activity creation.

In some embodiments, the alert system provides functionality where different groups of users must be serviced. For example, some group members may have internet while others have telephones; all members may have internet and some may have no agent while others have agents installed on their telephones. Alerts facilitate the determination of presence of these disparate groups of users.

In certain embodiments, presence-based services utilize presence determination features to provide new value for instant messaging, collaboration and chat-room capabilities supporting one-to-many and many-to-many communication. Agents and Fonemine server side capabilities can monitor, filter and trigger events and notifications and can be foundational elements in a systems requiring communicating presence awareness. Further, Fonemine servers can broker presence capabilities between multiple clients, with and without anonymity

In certain embodiments, location-based services may be inherently event-driven and events may be associated with notifications and responses associated with Fonemine servers.

In certain embodiments, alerts can be tied to events as well as search and collaboration: hence a search may trigger an alert or an alert may trigger a collaboration activity.

In certain embodiments, consumer and community focused activities are supported, including entertainment alerts such as notification of an album release date, or concert schedules and movie screenings. Such activities can also include price alerts indicating, e.g., price drops, informational alerts such as stock price movement and weather changes. Additionally, regular meeting notifications can be provided.

Alerts may be assigned a variety of purposes including supporting location based services that arc inherently event driven and can have notification and response functionalities associated with Fonemine server 22. Alerts can also indicate that a product or service has become available, thereby supporting product release marketing. Alerts can be used to indicate changes in pricing of a product or service to promote sales and can provide informational updates such as changes in stock price, current temperature or weather based on location or preconfigured request. Additionally, calendared events that can be periodic or programmed my be used to trigger one or more alerts.

The following examples illustrate the kinds of alerts that are supported:
a. Entertainment alerts such as “tell me when an album is released”, “when a concert schedule is announced” and “when a movie is going to be screened”
b. Price alerts: “tell me when price of xyz drops below $abc”.
c. Informational alerts: such as “the stock price of ABC is $abc” or the current temperature in city ABC is xyz.
d. Periodic alerts such as “Every third Tuesday of the month, at 5 pm, we meet at a certain place or we attend an event”
   Content Characteristics

Certain embodiments can exploit time, location of viewer and presence of viewer, as well as other characteristics of asynchronous communication. In some embodiments, time content can be published where, for example, content is prepared for publication in advance of a sale but is actually published only at a certain specific time. In some embodiments, time information includes expiry time indicating when a short duration event will end and such alerts can be used to support commercial activities by promoting limited time sales events, product availability announcements and auctions. In certain embodiments, alerts may be tailored to a subscriber or user needs and can combine temporal and location information in generating an alert. For example, a subscriber can provide alert content that is made time-critical because of viewer presence at a certain location. Content can be disseminated to viewers who have published their presence in applications where viewer presence is critical for chat-room like collaborative applications. In some embodiments, viewer location can be used to tailor content to specific locations. For example, content related to a Bay Area concert can be tailored to be published only for Bay Area local viewers.

In some embodiments, content can be classified by category and further classified by subcategories. Typically content is broadly classified based on content category as well as viewer interests and can be very useful in improving relevance of content. Examples of such content include business listings based on Yellow Pages.

Yet other embodiments can classify content via publication date or time-to-expiration or a combination of both. This classification is highly relevant for phone devices where timeliness is critical.

In some embodiments, content can be classified based on its “type”: i.e., whether it is text, or media, or some structured entity.

In some other embodiments, content is categorized based on its location and its scope (say for a group or a community, a city, or a region, or even a country).

In some embodiments content is categorized based on its source and attribution (in case multiple sources provide the same content).

Collaboration

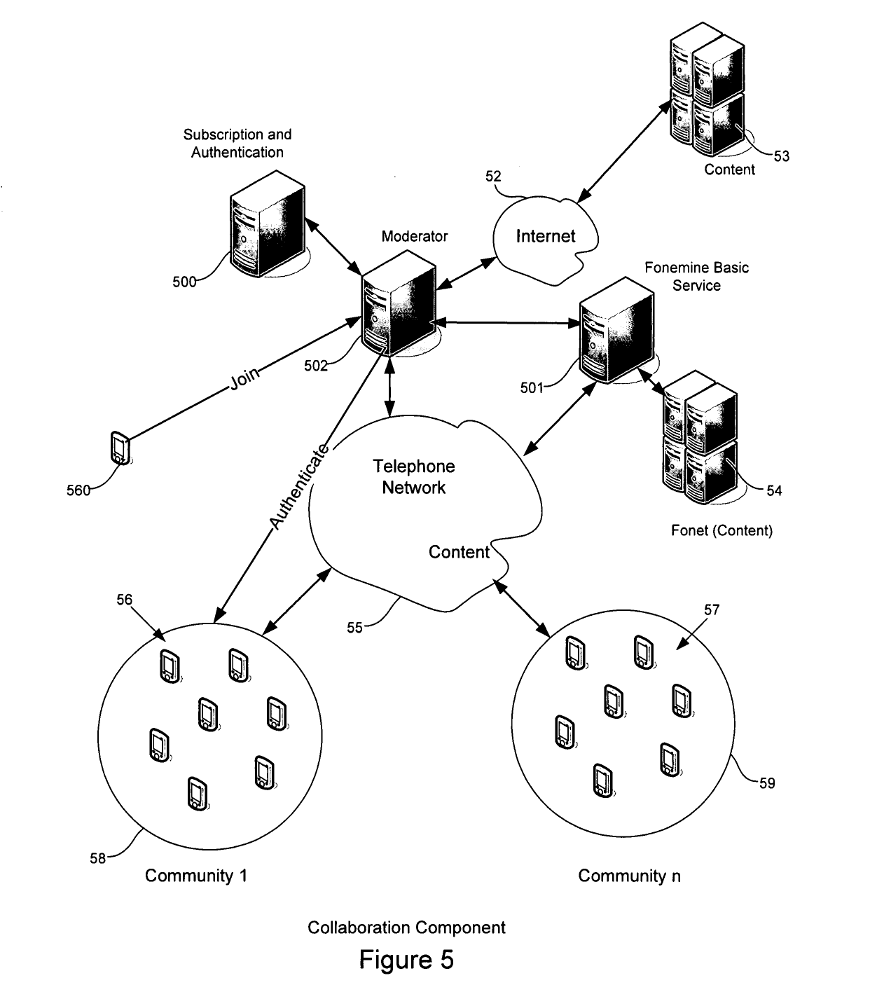

Referring now to FIG. 5, in certain embodiments, collaboration tools and capabilities are provided to users of phone devices to enable creation of dynamic collaboration groups. Collaboration tools can be useful for community activities and can be integrated with alerts and searches to maximize relevance of delivered content for the community. Typically, the community 58, 59 includes a group of mobile devices 56, 57 equipped with agent software Fonesurf or with just mobile internet access or even just text messaging or voice access. Content servers 54 can be adapted to provide content specifically directed to the community 58, 59 in the form of shared data and formatted as Fonepages that are shared for viewing and modification by all members of the community. Subscribers can join and leave communities using, for example, subscription server 50. Sessions may be supported for community activities and session-level authorizations can be provided to generate multiple reader and multiple writer accesses. Activities may be serialized and may be multimodal, having voice data and text characteristics. Sessions can be joined by community members freely, by rule or in response to community requests. Likewise, community members may leave a session at will or by command of the community.

In some embodiments, a collaboration session is just a voice call initiated on impulse by a moderator, into which multiple participants can be joined by virtue of the participants being called on their phone and opting in to the collaboration call. Such a collaboration session is described in utility patent application Ser. No. 11/644,766, filed Dec. 22, 2006 and titled “Service Initiated Voice Chat.”

In some embodiments, sessions can be moderated, typically using moderating services provided by a server 51 and different levels of participation can be controlled. In such embodiments, online delegation of control of content can be implemented. In some embodiments, community members are incentivized to provide or consume content. Typically, content is Fonemine managed and typically owned by subscribers or third parties. In certain embodiments, peer driven collaboration tools are provided. Fonemine services can also be used to create communities focused on specific interests: business communities such as a government community, or an industry consortium, also one focused on non-profit as well as personal communities such as single parents or accounting students. Creation of communities can be initiated by interested peers.

Commerce

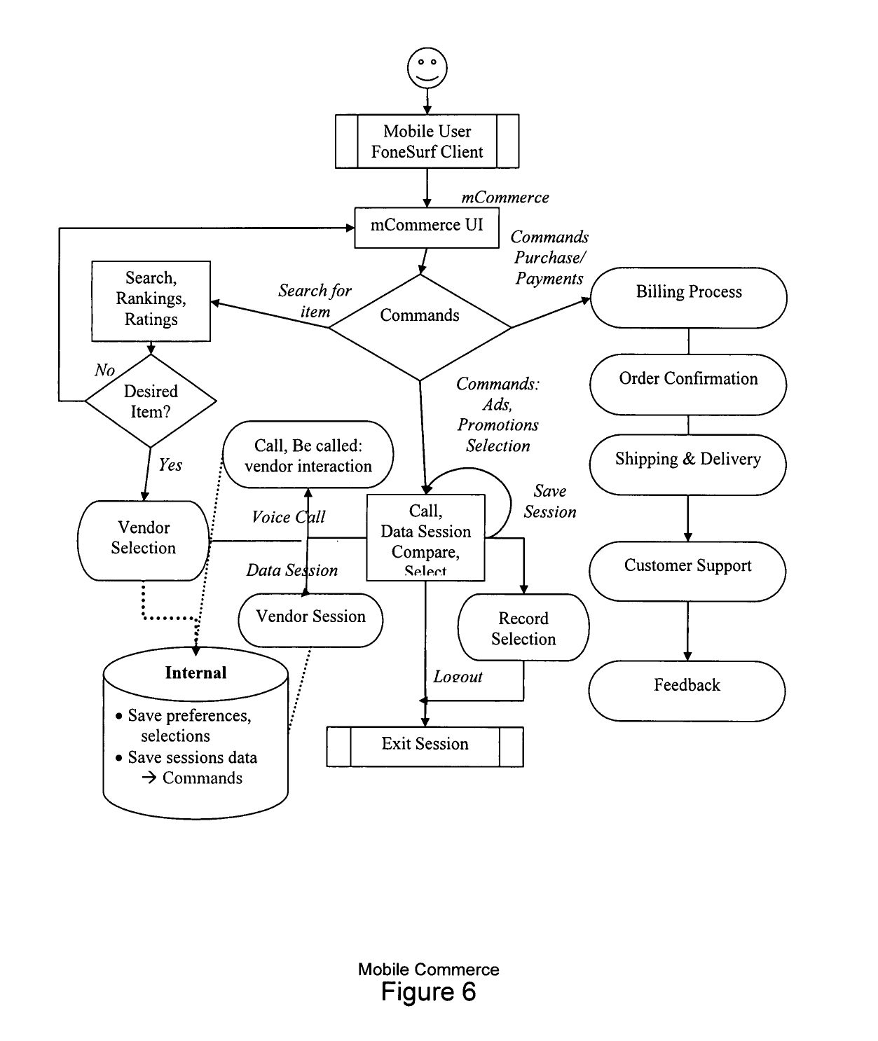

Referring now to FIG. 6, in some embodiments, commercial aspects of collaboration tools are emphasized. For example, a phone device can be used to initiate purchase of an item or subscribe to a service, to obtain a live-feed data stream, and to support various commercial transactions. In some embodiments, the purchase process includes searching for the item using search capabilities defined above, obtaining by telephone a choice of vendors offering an item for sale, obtaining vendor rankings, obtaining item rankings and reviewing similar and related items. Typically included are traditional rating and ranking lookup of vendor reputation and item quality as well as the ability for lookup of historically low transactions conducted through Fonemine service by other users.

In some embodiments, advertisements, coupons, rebates, sales information and promotions related to items may be provided by telephone. Such incentives can be provided based on session history, including search results and browsing activities. Commercial applications also may include options for selecting vendors from a list of available vendors. This selection process may include selection based on proximity of the vendors to the potential buyer or to a buyer-specified delivery address. The selection process may also include consideration of on online vendors, as well as Fonestore vendors (i.e. partners of Fonemine with further streamlined, value-added transaction support). In some embodiments, Fonemine service enables a vendor to hold an item, to preview a product or service by telephone, to place limit orders, to bid based on time- and cost-based availability and to offer one-click B&M pickup-time payment transaction based on telephone number and configuration and historical information maintained at a Fonemine server.

In some embodiments, a buyer can be connected to a vendor to complete purchase. Alternatively, a callback from vendor can be requested for finalizing a transaction. Additionally, dynamic Fonepages may be used to communicate with the vendor to complete purchase transaction. Dynamic Fonepages typically enable subscribers to select and complete information for transmission to a vendor, These Fonepages may be used to specify items for purchase and associated characteristics to the selling vendor

In many embodiments, vendors may respond with dynamic Fonepages. Vendor responses may include additional information and sales related information such as shopping cart and wish lists. In some embodiments, payment information may be provided using Fonepages. Pre-stored or dynamically entered information concerning credit cards and other forms of payment can be provided by telephone using voice and Fonepages: Other forms of payment can include user-defined payment methods associated with the Fonemine service account and telephone phone service billing.

In some embodiments, a telephone can be used for completing the process of purchasing including completing a transaction using a telephone or Fonepage, receiving order confirmation and order shipment and tracking information and obtaining delivery confirmation information. In certain embodiments, telephone based customer support using Fonepage navigation can be provided whereby the customer is connected to a support service multimodal. Typically customer service includes requesting and receiving feedback on products purchased and selling vendors for updating reviews, ratings and rankings.

In some embodiments, alerts and reminders related to purchasing needs may be provided. These alerts and reminders can include promotions on specific items on a buy or watch List. In certain embodiments, secured transactions can be facilitated in which payment information based on credit card, bank account and other forms of payment may be provided using a combination of voice communications and Fonepages. Other forms of payment include user-defined payment methods associated with the Fonemine service account and by telephone service provider billing. Transactions may be configured to generate alerts that indicate that either party should call the other party to confirm aspects of the transaction. When a transaction has been initiated, order shipment and delivery may be tracked using search and alert capabilities. Typically, search and alert tools can obtain information based on calendar and recorded transaction histories.

The Fonepage service can support commercial applications by providing configuration, historical information and security information associated with both buyer and seller. In some embodiments, alerts can be configured as purchasing reminders to provide information concerning promotions and watch lists that can identify availability of a product meeting certain criteria associated with location and price, for example. Vendors may provide immediate purchasing information to potential buyers using Fonepages customized to the buyer and product. Vendors may provide inventory information and rich inquiry filtering. For example, a buyer may issue a pre-qualify check on the item based on availability of item, availability window for in-person inspection, bottom-Line price point match and so on.

Advantages of embodiments of the present invention includes minimizing phone wait time, typically achieved because the selling vendor Fonepages can provide enough useful information about the products and services automatically and without delay in receiving human assistance. In some cases, a subscriber can also select items for purchase before connecting to a selling vendor telephone if needed for clarifications and facilitating payment etc. Further advantages include an ability to offer both seller and potential buyer inventory lookup and update capabilities as well as rich inquiry filtering, For example, a buyer can issue a pre-qualify check on an item based on availability of the item, an availability window for in-person inspection, bottom-line price point match. In some embodiments this latter process may include auction-like features for seller prequalification of serious buyers.

It is apparent that the above embodiments may be altered in many ways without departing from the scope of the invention. Further, the invention may be expressed in various aspects of a particular embodiment without regard to other aspects of the same embodiment. Still further, various aspects of different embodiments can be combined together. Accordingly, the scope of the invention should be determined by the following claims and their legal equivalents.

### Additional Description

Aspects of the Invention as Described Above Include:

Embodiments of the invention provide a method of publishing, sharing and viewing content in the form of Fonepages, specifically designed and optimized for phone devices on phone networks comprising the steps of providing displayable content at a mobile device the content including selectable objects, responsive to selection of at least one of the selectable objects, executing a search of one or more databases for information associated with the at least one selectable object, and providing the information to the mobile device, wherein the information includes an options for calling a number.

Certain embodiments of the invention provide a method for providing alerts, comprising providing a set of conditions to a server, the set of conditions including presence information associated with one or more users, generating an alert in response to satisfaction of predetermined conditions, and initiating one or more actions whereby the one or more actions includes establishing a connection between the one or more users.

Certain embodiments of the invention provide a method for telephonic collaboration between plural subscribers comprising providing a set of criteria to a plurality of subscribers for qualifying one or more may satisfy in order to join one or more communities, providing foundational common and shared content for each of the communities and initiating messaging and alert based communications between community members ranging from broadcast to chat sessions whereby selected members of the communities are authorized to access the content busing a telephone to perform functions including publishing, viewing, accessing, modifying and providing response and feedback to the content.

Certain embodiments of the invention provide a method for conducting commerce using mobile devices comprising performance of various steps of an end-to-end commercial transaction using existing telephone devices and existing telephone networks wherein the steps include searching for an object, rating and ranking for comparison, expressing intent to purchase goods or services, creating reservations, initiating certain commerce transaction based on incentives such as sales, coupons and promotions and tracking shipping and delivery to the buyer of goods and services.

For each of the embodiments described, functions including content access and provision, navigation and operations can be performed using voice and data communications.

What is claimed is:

1. A method of providing access to services and content on a mobile device, the method comprising:
receiving a content request from an agent on the mobile device;
receiving information associated with said mobile device;
forwarding the request to a service or content source;
receiving content from said service or content source;
formatting said content in a format customized for said mobile device wherein said format facilitates communication having a voice component, a text messaging component and a data component; and
transmitting said formatted content to said mobile device.

2. The method as recited in claim 1 further comprising:
checking access restrictions of said requested content.

3. The method as recited in claim 1 wherein said content is subject to access on a subscription basis.

4. The method as recited in claim 3 wherein said subscription allows a predetermined number of accesses within a given period.

5. The method as recited in claim 3 wherein a user is charged for accesses in excess of a predetermined number of accesses within a given period.

6. The method as recited in claim 1 wherein said content owned by service provider providing access to content on a mobile device.

7. The method as recited in claim 1 wherein said content is formatted in a multimodal format.

8. A method of handling search requests from a mobile device, the method comprising:
receiving a search request from a mobile device;
checking the search request against subscriber information;
dispatching the search request to a device for performing the search request;
receiving the results of the search request;
filtering the search results based on a location;
ranking the search results by relevance;
formatting the search results for the mobile device; and
transmitting the formatted search results to the mobile device.

9. The method as recited in claim 8 further comprising:
filtering the search results for access control;

10. The method as recited in claim 8 further comprising:
identifying categories within said search request; and
indexing the search results based on said categories.

11. The method as recited in claim 8 further comprising:
receiving information to be used for the brokering of a transaction.

12. The method as recited in claim 8 further comprising:
authenticating a user to simplify search requests for paid content.

13. The method as recited in claim 8 wherein the search results are ranked by monetization metrics.

14. The method as recited in claim 8 wherein said results are formatted based the display of said mobile device.

15. The method as recited in claim 8 wherein said search results are reduced in quantity for display on said mobile device.

16. The method as recited in claim 8 wherein said results are formatted based the input mechanisms of said mobile device.

17. The method as recited in claim 8 wherein said search request is stored to be repeated on a regular basis.

18. The method as recited in claim 8 wherein said search is scheduled to occur at a specific time or upon the occurrence of an event.

19. The method as recited in claim 8 wherein said search request comprises specific content sources to be searched.

20. The method as recited in claim 8 wherein said search request is performed based on user preferences.

21. The method as recited in claim 8 wherein said search is directed based on a history of prior searches.

22. The method as recited in claim 8 wherein said search is received over a protocol from the group consisting of SMS, GPRS, EDGE, EVDO, and 3G.

23. The method as recited in claim 8 wherein the quantity of said search results is based on user preferences.

24. The method as recited in claim 8 wherein said search results are cached on a server providing said search results.

25. The method as recited in claim 8 wherein said search results are cached at a location determined by a user.

26. The method as recited in claim 8 further comprising:
Initiating a call based on said search results.

27. The method as recited in claim 26 wherein said call is initiated between a provider of a product or service and a user.

28. The method as recited in claim 26 wherein said call is initiated between a content provider of content and a user.

29. The method as recited in claim 26 wherein said call is logged.

30. The method as recited in claim 26 wherein said call is mediated by a service provider receiving search requests.

31. The method as recited in claim 8 wherein said search results are saved for future use.

32. A system for delivering time sensitive information, the system comprising:
an alert delivery system for delivering time sensitive information in multimodal format coupled to a plurality of networks, wherein said system stores and applies a plurality of factors in the facilitating the delivering of said time sensitive information;
one or more client devices for receiving time sensitive information communicatively coupled to said alert delivery system, wherein said client devices can modify a plurality of conditions regarding the delivery of time sensitive information; and
one or more devices for subscribing to said information communicatively coupled to said alert delivery system, wherein said one or devices may be client devices.

33. The system of claim 32 wherein said information is delivered based on the presence of a specified user.

34. The system of claim 32 wherein said information is delivered based upon the availability of two or more parties.

35. The system of claim 32 wherein said information is delivered to notify or obtain presence information.

36. The system of claim 32 wherein said information is held for delivery at a desired time.

37. The system of claim 32 wherein said alert delivery system is integrated with a calendar system which enables scheduling and decision making processes for events.

38. The system of claim 32 wherein said alert delivery system facilitates polling of users.

39. The system of claim 32 wherein said alert delivery system aggregates responses and alerts from a plurality of devices to provide results based on a plurality of preset conditions.

40. The system of claim 32 wherein said alert delivery system facilitates communication between a plurality of devices with varying capabilities.

41. The system of claim 40 wherein said plurality of devices comprises: a computer, a mobile device, and land based telephone.

42. The system of claim 32 wherein said alert delivery system utilizes location based information for triggering events.

43. The system of claim 32 wherein said information is based on time and location.

44. A system of facilitating commerce, the system comprising:
a command processing module for receiving commands from said graphical user interface and passing said commands to an appropriate module coupled to a graphical user interface;
a graphical user interface for receiving commands from a user operating a client on a mobile device coupled to said command processing module;
a search module coupled to said command processing module for performing searches and providing search results of corresponding items or services, wherein multimodal communication between a vendor of said search result item is initiated after selection of said vendor by a user;
a purchase module for facilitating the purchase of an item or service in a multimodal format via said mobile device coupled to said command processing module; and
a promotion modules for providing product information and promotional information based on a plurality of factors coupled to said command processing module.

45. The system of claim 44 wherein said mobile device is used to initiate the purchase of a service.

46. The system of claim 44 wherein said search module returns dynamic content from vendors such as inventory.

47. The system of claim 44 wherein said search module returns ranking information.

48. The system of claim 44 wherein a user is connected to vendor to complete a purchase.

49. The system of claim 44 wherein said promotion module provides information based on session history.

50. The system of claim 44 wherein said promotion modules provides information based on location information received from a mobile device.

51. The system of claim 44 wherein said purchase module initiates a callback from a vendor to facilitate the completion of a purchase.

52. The system of claim 44 wherein said purchase module allows a user to connect to a support service multimodal.

53. The system of claim 44 wherein said promotion module issues alerts about specific products.

54. The system of claim 44 wherein said purchase module generates alerts to indicate that a party should make a call to confirm aspects of a transaction.

55. The system of claim 44 wherein said search module facilitates access to calendar information.

56. The system of claim 44 wherein said search modules facilitates access recorded transaction histories.

57. The system of claim 44 wherein said commerce module provides alerts based on watch lists.

58. A method of facilitating collaboration via mobile devices, the method comprising:
providing a set of criteria for qualifying one or more users in order to join one or more communities;
providing content for each of said one or more communities;
initiating communication between members of a community wherein members of the community are able to perform a plurality of activities with respect to the content within said community.

59. The method as recited in claim 58 wherein said activities comprise contributing content to said one or more communities.

60. The method as recited in claim 58 wherein said users can join and leave said one or more communities via a mobile device.

61. The method as recited in claim 58 wherein interactions with said one or more communities are multimodal.

62. The method as recited in claim 58 wherein said one or more communities are moderated.

63. The method as recited in claim 58 wherein said one or more communities is initiated by one or more peers.

64. The method as recited in claim 58 wherein said content is managed by a community service provider.
